(19) United States
(12) Patent Application Publication
(10) Pub. No.: US 2015/0337243 A1
(43) Pub. Date: Nov. 26, 2015

(54) COMPOSITION FOR CLEANING AND SEALING COATED SURFACES

(71) Applicant: Christopher A. Bozin, Long Grove, IL (US)

(72) Inventor: Christopher A. Bozin, Long Grove, IL (US)

(21) Appl. No.: 14/715,979

(22) Filed: May 19, 2015

Related U.S. Application Data
(60) Provisional application No. 62/000,587, filed on May 20, 2014.

(51) Int. Cl. C11D 7/50; C09K 15/12; C09K 15/04; C11D 7/34; C11D 7/24

(52) U.S. Cl. CPC C11D 7/5022; C11D 7/50; C11D 7/34; C11D 7/24; C09K 15/04; C09K 15/12

(57) ABSTRACT

A composition for cleaning and sealing coated surfaces like painted aluminum, coated tin, coated zinc, coated steel, and fiberglass. The composition includes a first solvent, preferably an aliphatic solvent, a second solvent, such as glycol ether, a first corrosion inhibitor, and a second corrosion inhibitor. The first corrosion inhibitor may be a water displacing agent, such as petroleum jelly, and may be in a 1:6 ratio to the second corrosion inhibitor. The second corrosion inhibitor may be calcium sulfonate. The solvents in the composition will remove oxidation on the surface and then evaporate, leaving behind the corrosion inhibitors which will form a sealant layer on the surface.

### RELATED APPLICATIONS

This application claims priority to U.S. Provisional Application No. 62/000,587, filed on May 20, 2014, the entirety of which is incorporated herein by reference.

### FIELD OF THE INVENTION

This invention relates to compositions used to clean and seal coated surfaces, such as painted aluminum, fiberglass, coated tin, coated zinc, and coated steel.

### BACKGROUND OF THE INVENTION

The use of painted aluminum for a variety of applications is very common. In addition to being painted, the aluminum surface, and more particularly, the exterior surface of the paint, is covered with a thin layer of sealant to protect and maintain the look of the painted aluminum.

Painted aluminum may be used, for example, as trim to cover mounting structures for doors and windows of a building, such as a house. Additionally, painted aluminum can be used to cover other portions of a building, like, for example, soffits and fascia. Compared to wood, the painted aluminum requires less maintenance and generally maintains a desired look for a greater length of time.

Painted aluminum can also be used for other outdoor products, such as patio furniture, lights, ornamental decorations and the like. In comparison to steel or wood, painted aluminum has sufficient structural integrity, but it is relatively light.

Eventually, however, most painted aluminum products will lose their original look. The coating on the painted aluminum may oxidize and produce a surface with a white, flaky substance that resembles chalk. Similarly, the luster of the painted aluminum surface will also fade, become discolored, or both. While not intending to be bound by any particular theory, it is believed that these problems are mainly a result of the exposure of the painted aluminum to ultraviolet sunlight and oxygen in the atmosphere. The ultimate result of these problems is that the painted aluminum product no longer has the desired appearance.

Replacing painted aluminum products can be expensive. For example, replacing doors and windows can cost thousands of dollars. Additionally, if the windows and doors are still operational, it is unnecessary and environmentally undesirable to replace the windows and doors.

Similarly, replacing functional outdoor furniture merely because the furniture has an unattractive appearance can also be expensive. Also, if the furniture is still functional, replacing it is unnecessary and environmentally undesirable.

Instead of replacing the aluminum products, there are known products which can be used to clean the surface of the aluminum products and which attempt to restore the original look and luster. Using such a composition is a less expensive solution (compared to replacing the products) to address the undesired look of the aluminum products and may be more environmentally friendly.

While these compositions may be effective for their intended purposes, such compositions may have various drawbacks. For example, some known compositions are acidic or contain dangerous chemicals which have the potential to cause injuries to the person applying the cleaner, undesirably react with other objects, damage the environment, or cause other problems.

In addition to these drawbacks, some compositions may sufficiently clean the painted aluminum surface but require additional steps or compositions to re-seal the surface. Conversely, some compositions may sufficiently seal the painted aluminum surface but require additional compositions to clean the surface.

A similar exposure-related problem can be observed on other surfaces that are coated with a protective layer, such as anodized metals like tin or zinc or an inorganic surface such as fiberglass. Indeed, fiberglass is used on a variety of outdoor products. As with painted aluminum, exposure to the atmosphere and ultraviolet light are believed to cause the fiberglass surface to become discolored, cloudy, or lose its luster.

Replacing fiberglass products can also be expensive and environmentally undesirable. While it is possible that fiberglass could be cleaned with a composition, it is believed that any such cleaning compositions would suffer from the same drawbacks discussed above, namely, dangerous chemicals, or multiple compositions.

Accordingly, it would be desirable to have a composition that is safe and that can both clean and seal a coated surface in a single application.

### SUMMARY OF THE INVENTION

The present invention is directed to a composition for cleaning a coated surface by removing oxidation and sealing the surface.

In an exemplary embodiment of the present invention, the composition includes at least about 50% by weight of an aliphatic solvent, an effective amount of a second solvent, an effective amount of a first corrosion inhibitor, and, between 15% to 36% by weight of a second corrosion inhibitor. The ratio of the first corrosion inhibitor to the second corrosion inhibitor can be approximately 1:6.

While this invention is susceptible of embodiments in many different forms, there will herein be described in detail one or more embodiments with the understanding that the present disclosure is to be considered as an exemplification of the principles of the invention and is not intended to limit the invention to the embodiments discussed.

### DETAILED DESCRIPTION

A new composition which can restore certain surfaces back to a near original-like condition has been discovered. The novel composition is easily applied, safe for handling, and produces lasting results. The composition functions as both a cleaning composition and a sealing composition.

In one or more embodiments of the present invention, a composition for cleaning and sealing a surface includes a first solvent, a second solvent, a first corrosion inhibitor, and a second corrosion inhibitor.

The first solvent maintains at least one of the corrosion inhibitors in suspension form. Additionally, the first solvent preferably cleans the surface by removing the oxidation. The first solvent is preferably an aliphatic solvent, such as Calumet 300-360 produced by Calumet Specialty Product Partners of Indianapolis, Ind., US. Such aliphatic solvents may include hydrotreated and straight distillate solvents produced from crude oil and may include, for example, hexanes and heptanes. Additionally, such solvents may comprise mixtures of C₁₅ paraffin hydrocarbons to C₄₀ paraffin hydrocarbons. While not intending to be bound by any particular theory, it is believed that the aliphatic solvent dissolves the oxidation from the sealant.

Preferably, the composition includes at least 50% by weight of the first solvent, or at least 55% by weight, or at least 60% by weight, or at least 65% by weight, or 69% by weight. It should be appreciated that these numbers are approximates and that +/−2% weight is an acceptable tolerance. Similar to the first solvent, the second solvent acts as a cleaning agent and maintains at least one corrosion inhibitor in suspension until application. The second solvent may be glycol ether, such as ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether, ethylene glycol dimethyl ether, ethylene glycol diethyl ether, ethylene glycol dibutyl ether, ethylene glycol methyl ether acetate, ethylene glycol monoethyl ether acetate, ethylene glycol monobutyl ether acetate, or mixtures thereof.

The composition typically includes an effective amount of the second solvent, which preferably is about 3%, or at least 1%, at least 1.5%, at least 2%, or at least 2.5%.

It is contemplated that the ratio of first solvent to second solvent is preferably approximately 10:1, or approximately 13:1, or approximately 15:1.

In addition to the first and second solvents, as mentioned above, a composition according to the present invention includes a first second corrosion inhibitor and a second corrosion inhibitor. The first corrosion inhibitor and the second corrosion inhibitor together will form a sealant layer over the surface after the composition has been applied, and the solvents have evaporated.

The first corrosion inhibitor may be a water displacing agent, such as petroleum jelly. Other hydrophobic compounds may be used, for example compounds derived from plant oils and waxes, for example, carnauba wax, or wax derived from coal or other geological material, such as montan wax, or microcrystalline wax. Other waxes may include beeswax and candelilla wax, to name a few.

A composition according to the present invention includes a first corrosion inhibitor present in an effective amount, such as, for example, about 4% by weight, or about 3.5%, or about 3%, or about 2.5%, or about 2%, or about 1.5%, or about 1%, or between about 1% to 5%.

The second corrosion inhibitor may be a calcium, barium or other metal phenates or sulfonates, for example a calcium sulfonate, such as ALOX® 2165, from The Lubrizol Corporation, Wickliffe, Ohio, US. The composition may include between 15% to 36% by weight of the second corrosion inhibitor, or 20% to 30% by weight, or 22% to 28% by weight, or 24% by weight. A ratio of the first corrosion inhibitor to the second corrosion inhibitor is preferably about 1:6, but may be in the range of 1:4 to 1:8.

Insufficient amounts of one or more of the solvents will produce a composition that fails to maintain the corrosion inhibitors in suspension properly. In storage, this may result in the corrosion inhibitors agglomerating and falling out of suspension.

Upon application of the composition to the surface, a composition with an insufficient amount of one or more of the solvents will result in the corrosion inhibitors agglomerating too quickly. This will produce an undesirable result on the surface by showing “streaks.”

On the other hand, an excess amount of one or more of the solvents will produce a composition that may not maintain the restored look on the surface for the desired amount of time. Concomitantly, if the composition has an insufficient amount of one or more of the corrosion inhibitors, it has been found that the restored look of the surface may not last as long as desired.

However, if there is an excess of one or more of the corrosion inhibitors, the corrosion inhibitors may begin to agglomerate and fall out of suspension. Furthermore, application of such a composition may result in a sealant layer that is too thick and has an undesirable look.

In one embodiment, a composition of the present invention includes about 69% by weight of an aliphatic solvent, about 3% by weight of a second solvent, about 4% by weight of a first corrosion inhibitor, and, about 24% by weight of a second corrosion inhibitor.

In another embodiment, the composition of the present invention includes about 69% by weight of an aliphatic solvent, about 3% by weight of glycol ether, about 4% by weight of petroleum jelly, and, about 24% by weight of calcium sulfonate.

In use, a composition according to the present invention may be applied to a surface with any type of material, for example, cotton, cotton blends, or microfiber materials. The composition can be applied without requiring much force onto the surface because the solvent removes the oxidation and cleans the surface. Furthermore, it is not necessary to apply the composition to all the crevices and apertures of a surface because the composition will flow into the crevices and apertures upon application to the surface. Thus, a restored look can be easily obtained for a detailed surface without requiring special application tools or materials.

For surfaces in direct sunlight, the compositions may be applied in ambient temperatures as low as about 4° C. (40° F.) to as high as about 23° C. (75° F.). For surfaces not in direct sunlight, the compositions may be applied in ambient temperatures from about 4° C. (40° F.) to about 35° C. (95° F.). Additionally, the temperature of the surface may also influence the ability to apply the compositions.

A typical time for evaporation of the solvents is between 10 minutes to 12 hours depending on different variables, such as the ambient temperature, the temperature of the surface, and whether the surface is exposed to sunlight or another ultraviolet light source. As might be expected, a lower temperature will increase the amount of time needed for the solvents of the composition to evaporate. Additionally, a high level of humidity will increase the time needed for the solvents to evaporate. Finally, the material of the underlying surface can also affect the time needed for the solvents to evaporate.

Once the solvents have evaporated, the corrosion inhibitors will remain on the surface, forming a sealing layer over the surface that protects the underlying surface from oxygen, water, ultra violet light and physical damage.

In some instances, only a single application of the composition will be needed to clean the surface, remove any oxidized portions, and leave behind enough corrosion inhibitors to form a sufficient sealant layer. However, it is contemplated that two or more applications of the composition may be utilized to achieve maximum cleaning and protection. Moreover, since the same composition both seals and cleans the surface, the same cloth may be used in multiple applications.

A surface cleaned and sealed with a composition according to one or more embodiments of the present invention can expect to retain its restored look for at least six months, and most likely a longer period of time, depending in part on the exact amounts of the constituents in the composition, as well as climate and other external factors.

An experimental application of a composition according to the present invention was performed on painted aluminum window trim, painted aluminum furniture, and fiberglass on a hot tub. All of these surfaces were treated in a summer month of a humid continental climate. Most of the surfaces received two or three applications of the preferred composition.

The restored look of the cleaned and sealed surfaces was evident immediately after application of the composition. After approximately 8 months, which included winter exposures, all of the surfaces retained the restored look. Water testing on the treated surfaces evidenced sustained sealing abilities as water continued to bead on the surface, months after application. It is believed that the surfaces will maintain the restored look for at least one year and possibly up to five years.

Additional testing was conducted by applying a composition to coated tin, coated zinc and coated steel substrates. The results were similar, with the weathered surfaces of the substrates being returned to their restored look almost immediately after application of the composition. Accordingly, the various compositions of the present invention can be applied to a variety of coated surfaces to restore the original look to same.

Thus, a composition according to the various embodiments of the present invention provides a safe and relatively inexpensive way to restore the look of surfaces like painted aluminum and fiberglass. After application, the treated surface will have a restored look that is very similar to the original look. The ability to restore the look of the treated surface has aesthetic value, and it may also increase the life of the object with the treated surface as consumers may be less likely to replace the object if it is easy and economical to restore.

Furthermore, a composition according to one or more embodiments of the present invention will both clean and seal the surface. As will be appreciated, having a single composition that does both will save a consumer money, space, and time in the application process.

Additionally, a composition according to one of more of the embodiments of the present invention is relatively safe for handling and may not produce any harmful or poisonous vapors. Similarly, a composition according to one of more of the embodiments of the present invention is environmentally friendly.

These and other benefits of the present invention will be apparent to those of ordinary skill in the art in view of the present disclosure.

While the principles of the invention have been described above in connection with specific examples and applications, it is to be understood that this description is made only by way of example and not as a limitation on the scope of the invention.

Claimed is:

1. A composition for cleaning and sealing a surface, the composition comprising:
at least about 50% by weight of an aliphatic solvent;
an effective amount of a second solvent;
an effective amount of a first corrosion inhibitor; and,
between 15% to 36% by weight of a second corrosion inhibitor, the ratio of the first corrosion inhibitor to the second corrosion inhibitor being approximately 1:6.

2. The composition of claim 1 wherein the second corrosion inhibitor comprises calcium sulfonate.

3. The composition of claim 2 further comprising:
approximately 24% by weight of calcium sulfonate.

4. The composition of claim 1 wherein the first corrosion inhibitor is petroleum jelly.

5. The composition of claim 1 wherein the second solvent comprises glycol ether.

6. The composition of claim 1 further comprising:
about 3% by weight of glycol ether.

7. The composition of claim 1 wherein the first corrosion inhibitor comprises petroleum jelly, and the composition further comprises:
about 4% by weight of petroleum jelly.

8. The composition of claim 1 further comprising:
at least about 60% by weight of an aliphatic solvent.

9. The composition of claim 1 further comprising:
about 69% by weight of an aliphatic solvent.

10. The composition of claim 9 wherein the second solvent comprises a glycol ether.

11. The composition of claim 1 wherein a ratio of the first solvent to the second solvent is 13:1.

12. A composition for cleaning and sealing a surface, the composition comprising:
about 69% by weight of an aliphatic solvent;
about 3% by weight of a second solvent;
about 4% by weight of a first corrosion inhibitor; and,
about 24% by weight of a second corrosion inhibitor.

13. The composition of claim 12 wherein the second solvent comprises glycol ether.

14. The composition of claim 12 wherein the first corrosion inhibitor comprises petroleum jelly.

15. The composition of claim 12 wherein the first corrosion inhibitor comprises a water displacing agent.

16. The composition of claim 12 wherein the second corrosion inhibitor comprises calcium sulfonate.

17. The composition of claim 13 wherein the second corrosion inhibitor comprises calcium sulfonate.

18. The composition of claim 14 wherein the second corrosion inhibitor comprises calcium sulfonate.

19. The composition of claim 15 wherein the second corrosion inhibitor comprises calcium sulfonate.

20. A composition for cleaning and sealing a surface, the composition comprising:
about 69% by weight of an aliphatic solvent;
about 3% by weight of glycol ether;
about 4% by weight of petroleum jelly; and,
about 24% by weight of calcium sulfonate.
